(19) United States
(12) Patent Application Publication
(10) Pub. No.: US 2008/0026734 A1
(43) Pub. Date: Jan. 31, 2008

(54) Method And System For Communicating Information Within A Physical Link Layer

(76) Inventor: David Srodzinski, Edinburgh (GB)

Correspondence Address: EDWARDS ANGELL PALMER & DODGE LLP, P.O. BOX 55874, BOSTON, MA, 02205, US

(21) Appl. No.: 10/587,649

(22) PCT Filed: Jan. 31, 2005
(86) PCT No.: PCT/GB05/00327

§ 371 Date: Apr. 30, 2007

(30) Foreign Application Priority Data
Jan. 31, 2004 (GB) 0402176.2

(51) Int. Cl. H04L 29/06

(52) U.S. Cl. 455/414.3

(57) ABSTRACT

A method and apparatus is disclosed that allows data communication within a packet based communication system by incorporating information within the physical link layer. Information is communicated from a transmitter to a receiver within the physical link layer by substituting idle data fields with input data fields. The transmitter comprises a data insertion multiplexer to generate and insert physical link layer data, and the receiver comprises a data extraction de-multiplexer to detect and extract the physical link layer data.

This invention relates to the field of packet based communications systems. More particularly, this invention relates to a method and apparatus that permits direct communication of information between elements within the physical link layer of a packet based communication system.

### BACKGROUND ART

A schematic representation of an Open Systems Interconnection (OSI) model 1 is presented in FIG. 1. The OSI model 1 is a seven layer reference model recommended by the International Standards Organisation (ISO) to provide a logical structure for network operations protocol. Within the OSI model 1 a Physical Link Layer 2 is defined as the lowest layer and above this lies a Datalink Layer 3. The Datalink layer has several functions 3, but within a packet based communication system the Datalink layer 3 performs the task of encoding and decoding a data stream into discrete data packets.

The Physical Link Layer 2 is often conveniently subdivided into a Physical Coding Sub-layer (PCS) 4, a Physical Media Attachment (PMA) layer 5 and a Physical Media Device (PMD) layer 6. The PCS 4, further encodes the packet data suitable for transmission across the physical media. The PMA 5 provides an attachment layer between PCS 4 and the PMD 6. The PMD 6 is responsible for the physical transmission of the signal.

FIG. 2 presents a schematic representation of a packet based communication system 7, as is known to those skilled in the art e.g. an Ethernet or a Fibre Channel systems. The packet based communication system 7 is shown in a simplified form so as to comprise a transmitter 8 that performs the tasks of the PMD layer 6 and optionally also the PMA layer 5. The transmitter 8 acts to convert the packet encoded electrical input signal “in” 9, produced within the higher Datalink layer 3 and PCS layer 4, into a data packet signal 10 suitable for transmission through a propagation medium 11. In this example the data packets 10 comprise optical signals for transmission through an optical fibre. At the output of the propagation medium 11 is located a receiver 12. The receiver 12 is employed to detect the signals in a PMD layer 6 and PMA layer 5 device and convert them into an electrical output signal “out” 13 for packet de-coding within the PCS layer 4 and Datalink layer 3 of the packet based communication system 7.

Further detail of the transmission of a data stream, comprising a plurality of data packets 10, within the propagation medium 11 is shown in FIG. 3. These schemes are employed by IEEE 802.3 Ethernet, ANSI Fibre Channel, OIF SPI and SFI Physical Link Layer Standards.

It is known to those skilled in the art that the data packets 10 are required to be dispersed with idle data fields 14 which are again produced within the Datalink layer 3 of the packet based communication system 7.

In particular, the data packets 10 are encoded so as to only contain certain data characters, and prohibit others, and are further delimited by special formatting characters that act to frame the data packets 10. The idle data field 14 contains other special and unique data characters that make them very distinct from the data packets 10. For example, in the Ethernet standard 802.3 Clause 36, the idle data fields 14 comprise the comma character, alternatively called a K28.5 pattern, that has one unique 10-bit word pattern 1100000101. During the idle period no data is conveyed from the transmitter 8 to the receiver 12, the idle data fields 14 being required only to retain the link “up” status between the transmitter 8 and the receiver 12 so as to retain data clock synchronisation at the receiver 12.

Within the aforementioned packet based communications systems there is no facility, post packet encoding, for inserting or extracting information at the Physical Link Layer 2, within the PMA layer 5 or the PCS layer 4. Thus, once the electrical input signals “in” 9 have been encoded as packets within the standard Datalink layer 3 or the PCS layer 4 there is no means within the prior art systems for exploiting the substantially unused idle data fields 14.

It is an object of an aspect of the present invention to provide a method and apparatus that permits direct communication of information between elements within the physical link layer of a packet based communication system.

According to a first aspect of the present invention there is provided a method of communicating information within the physical link layer of a packet based communication system that comprises the steps of:

1) Employing a physical link layer transmitter to substitute an additional input data field within an idle data field of a data stream transmitted within the packet based communication system; and

2) Employing a physical link layer receiver to extract the additional input data field without corrupting information contained within the data stream.

Preferably the step of substituting an additional input signal within an idle data field comprises the steps of:

1) Detecting one or more idle data field characters; and

2) Replacing the one or more idle field data characters with a physical link layer data character.

Optionally the one or more idle field data characters to be replaced are located within two or more of the idle data fields.

Preferably the step of extracting the additional input data field without corrupting information contained within the data stream comprises the steps of:

1) Detecting one or more physical link layer data characters; and

2) Extracting and replacing the one or more physical link layer data characters with idle field characters.

Preferably the step of replacing the one or more idle field data characters with the physical link layer data characters comprises replacing one or more idle field data characters with a start data insertion multiplexer character.

Preferably the step of replacing the one or more idle field data characters with the physical link layer data characters further comprises replacing one or more idle field data characters with a data control character.

Preferably the step of replacing the one or more idle field data characters with the physical link layer data characters comprises replacing one or more idle field data characters with an additional input data character.

Optionally the step of replacing one or more idle field data characters with the physical link layer data characters further comprises the step of replacing one or more idle field data characters with an end input data character.

Preferably the step of detecting the physical link layer data comprises activating a data extraction de-multiplexer when the receiver detects one or more start data insertion multiplexer characters.

According to a second aspect of the present invention there is provided a packet based communication system comprising one or more transmitters, one or more transmission media and one or more receivers wherein at least one of the one or more transmitters comprises a data insertion multiplexer for generating and inserting physical link layer data, and at least one of the one or more receivers comprises a data extraction de-multiplexer for detecting and extracting the physical link layer data.

### BRIEF DESCRIPTION OF DRAWINGS

In the following detailed description of the preferred embodiments or mode, reference is made to the accompanying drawings, which form part hereof, and in which are shown, by way of illustration, specific embodiments in which the invention may be practised. It is to be understood that other embodiments may be utilised and structural changes may be made without departing from the scope of the present invention.

FIG. 1 shows a schematic representation of a prior art Open Systems Interconnection (OSI) model;

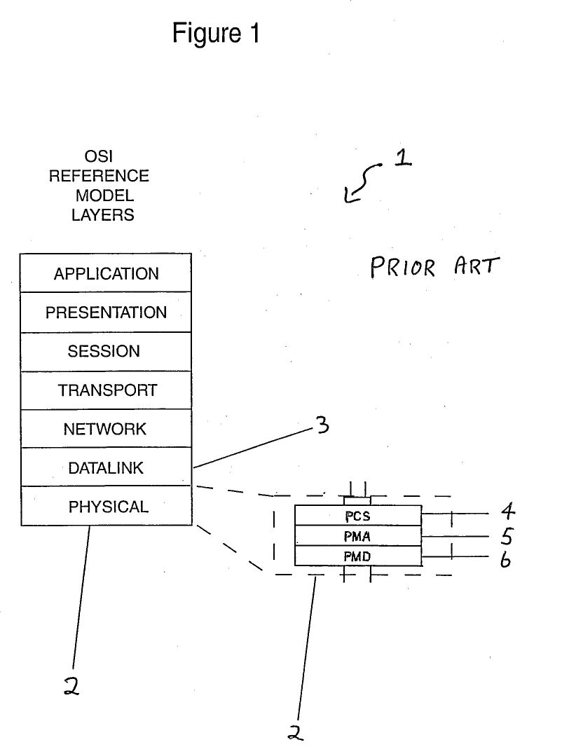

FIG. 2 shows a typical prior art packet based communications system at the physical link layer;

FIG. 3 shows a typical data packet transmission within the communications system of FIG. 2;

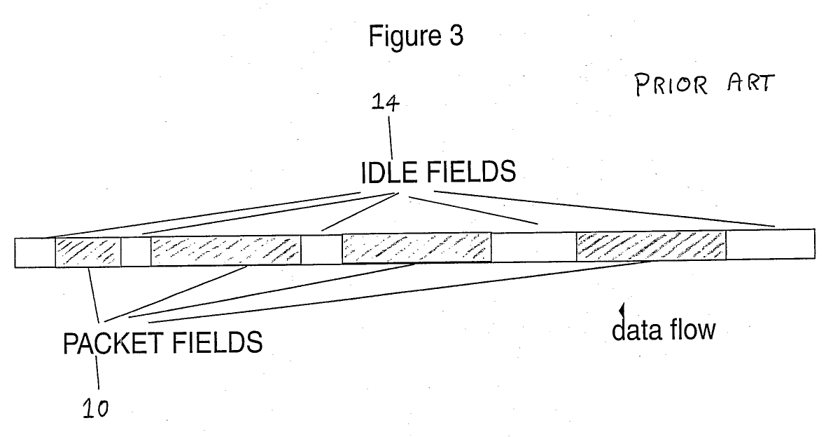

FIG. 4 shows a packet based communications system at the physical link layer that employs the method and apparatus for inserting an additional field in accordance with aspects of the present invention;

FIG. 5 shows a schematic representation of the additional data field when inserted between two data packets by the packet based communications system of FIG. 4;

FIG. 6 shows details of a coding field of the additional data field of FIG. 5;

FIG. 7 shows a flow diagram of the method employed by a data insertion multiplexer of a transmitter of FIG. 4, employed to insert the additional data field; and

FIG. 8 shows a flow diagram of the method employed by a data extraction de-multiplexer of a receiver of FIG. 4, employed to extract the additional data field.

### DETAILED DESCRIPTION

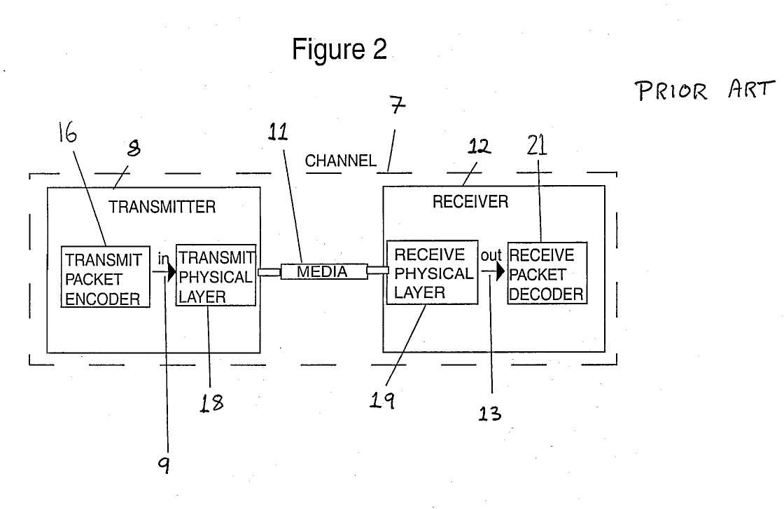

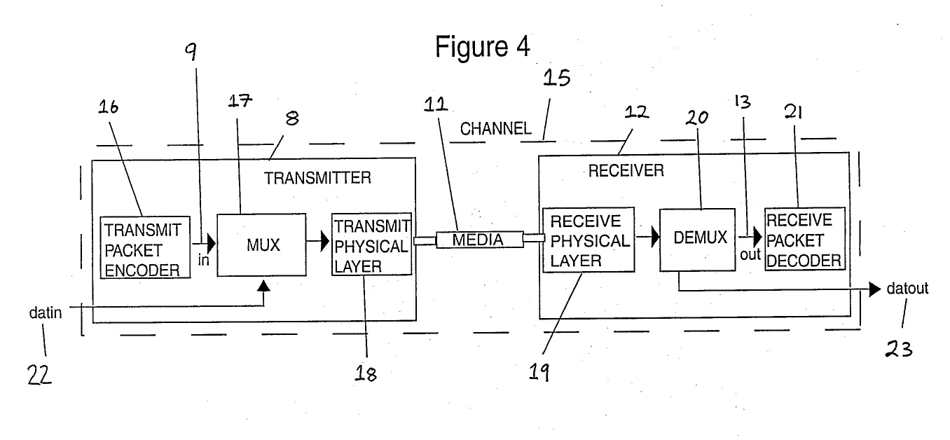

A packet based communications system 15 at the physical link layer that employs a method of inserting an additional field in accordance with an aspect of the present invention, is presented in FIG. 4. The physical link layers of the packet based communications system 15 can be seen to comprise common elements with the prior art system shown in FIG. 2, and described above, therefore for clarity purposes the same reference numerals are employed throughout, as appropriate.

The packet based communications system 15 can be seen to comprise a transmitter 8, a propagation medium 11 and a receiver 12. The form of the data packets 10 generated by the transmitter 8 are again controlled by an electrical input signal “in” 9 produced within the Datalink layer 3 before reaching the physical link layer of the packet based communication system 15. The receiver 12 again is employed to convert the detected data packets 15 into an electrical output signal “out” 13 for use within the datalink layer 3 of the packet based communication system 15.

The transmitter 8 is partitioned into a data packet encoder source 16, a data insertion multiplexer element (MUX) 17 and an physical output stage 18. The signal transmitted via the propagation medium 11 is received at the receiver 12, which has been partitioned into an physical input stage 19, a data extraction de-multiplexer element (DEMUX) 20 and a data packet decoder 21. An additional input data “datin” 22 field can be inserted within the normal input signal “in” 9 by the MUX 17, as described below. The additional input data 22 can then be extracted by the DEMUX 20, so as to provide a “DatOut” 23 signal in addition to the normal output signal “out” 13, as described below.

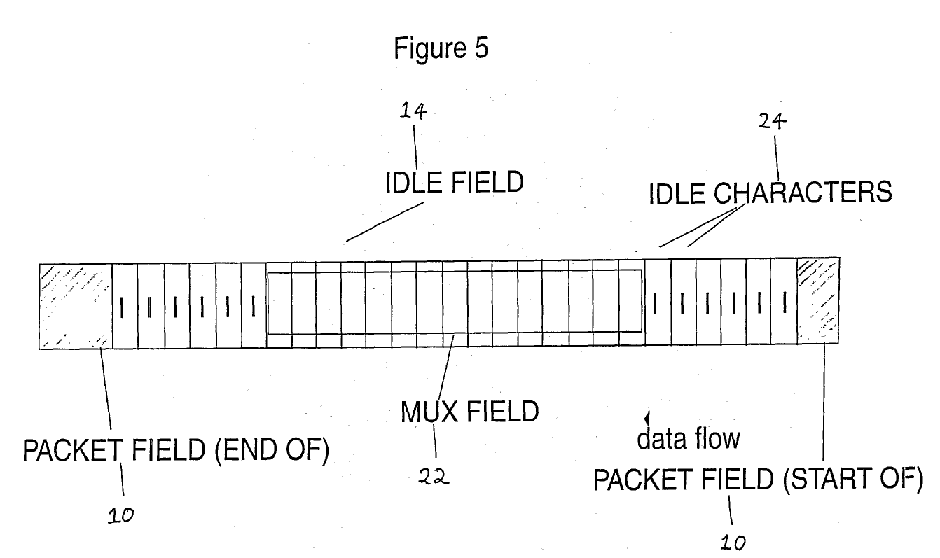

FIG. 5 shows an example additional input data “DatIn” 22 field inserted between two data 10 of a transmitted signal. The additional input data “DatIn” 22 field is inserted by employing the MUX 17 to replace a portion of the idle data field 14 by swapping out individual idle field characters 24. In a reciprocal manner the additional output data “DatOut” 23 field is extracted by employing the DEMUX 20 to replace the additional input data “DatIn” 22 field by swapping in individual idle field characters 24.

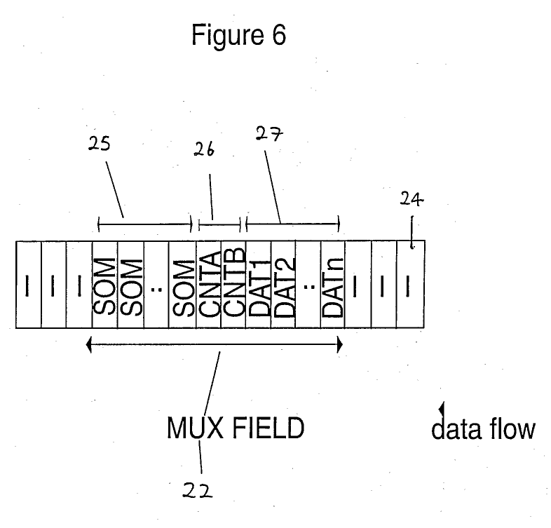

FIG. 6 shows detail of a coding scheme employed within the additional input data “DatIn” 22 field so as to provide for its insertion and extraction. The coding field can be seen to comprise three distinct sub fields namely, a series Start Of MUX characters (SOM) 25, control characters CNT_{A} and CNT_{B} 26 or a plurality of data characters DAT₁ to DAT_{N} 27.

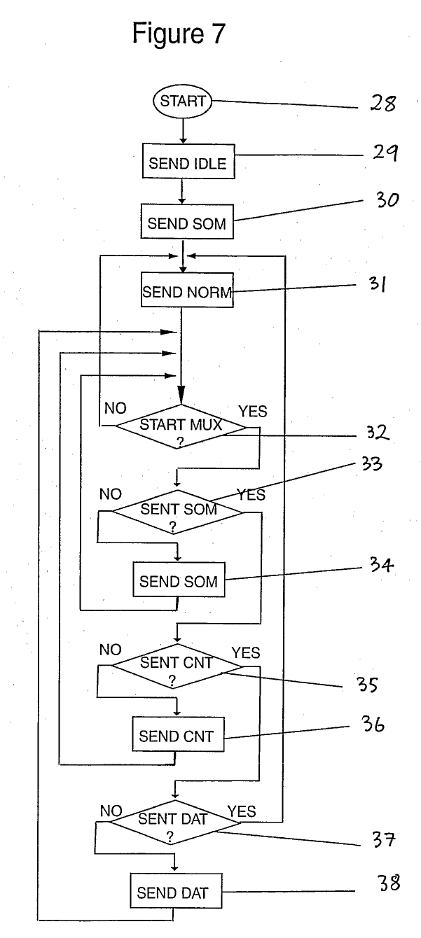

FIG. 7 presents a flow diagram of, the method employed by the MUX 17 of the transmitter 8 when operating to insert the additional input data “DatIn” 22 field. In general the states are advanced and decisions are made on the arrival of each character from the data packet encoder source 16.

Transmitter START 28, SEND IDLE 29 and SEND SOM 30 stages are included and all correspond to the initial activation of the transmitter 8, as is known to those skilled in the art. In particular, the Transmitter START 28 stage is typically determined by a power on condition, an external reset, or a manual reset override. Following the Transmitter START 28 stage the MUX 17 inserts an initial sequence of idle field characters (not shown) into the data stream being sent to the channel receiver by employing the SEND IDLE 29 stage. The idle field characters are in a sufficient amount to allow data recovery synchronisation in the channel receiver as per an appropriate standard, and typically comprise a programmable quantity. After the initial idle sequence, SOM characters (not shown) are sent by the SEND SOM 30 from the MUX 17. These SOM characters (not shown) are employed to clearly indicate that additional input data is to be sent and are required to be easily distinguishable from the idle characters and the start of data packet characters. Again the actual number of SOM characters (not shown) sent is typically a user programmable quantity.

The next stage involves the transmission of the normal data packets 10 by the MUX 17, as represented by a SEND NORM 31 stage. This continues until such time that START MUX 32 stage sets a YES branch that occurs when the MUX 17 continuously detects idle characters 24. The particular number of idle characters required to set the. YES branch is user programmable. The START MUX 32 branches NO immediately on the next character, if a data packets 10 is detected in the data stream, regardless of whether the full additional input data “DatIn” 22 has been sent so preventing any corruption of the normal data packets 10.

A SENT SOM ? 33 stage then branches YES only when a suitable, programmable, quantity of SOM characters 25 have been sent. If a SENT SOM ? 33 NO condition occurs then an additional SOM character 25 is sent by a SEND SOM 34 stage of the MUX 17. Following the SOM character 25 being sent the state returns back to START MUX 32 and continues with the insertion of the additional input data “DatIn” 22 only if no non idle characters 24 are present in the data stream from the packet encoder 16.

Next a SENT CNT ? 35 stage branches YES only when a suitable, programmable, quantity of CNTᵢ characters 26 have been sent. If a SENT CNT ? 35 NO condition occurs then an additional CNTᵢ character 26 is sent by a SEND CNT 36 stage of the MUX 17. Following the CNTᵢ character 26 being sent the state returns back to START MUX 32 and continues with the insertion of the additional input data “DatIn” 22 only if no non idle characters 24 are present in the data stream from the packet encoder 16.

A SENT DAT ? 37 stage then branches YES only when a suitable, programmable, quantity of DAT characters 27 have been sent. If a SENT DAT ? 37 NO condition occurs then an additional DAT character 27 is sent by a SEND DAT 38 stage of the MUX. Following a DAT character 27 being sent the state returns back to START MUX 32 and continues with the insertion of the additional input data “DatIn” 22 only if no non idle characters 24 are present in the data stream from the packet encoder 16.

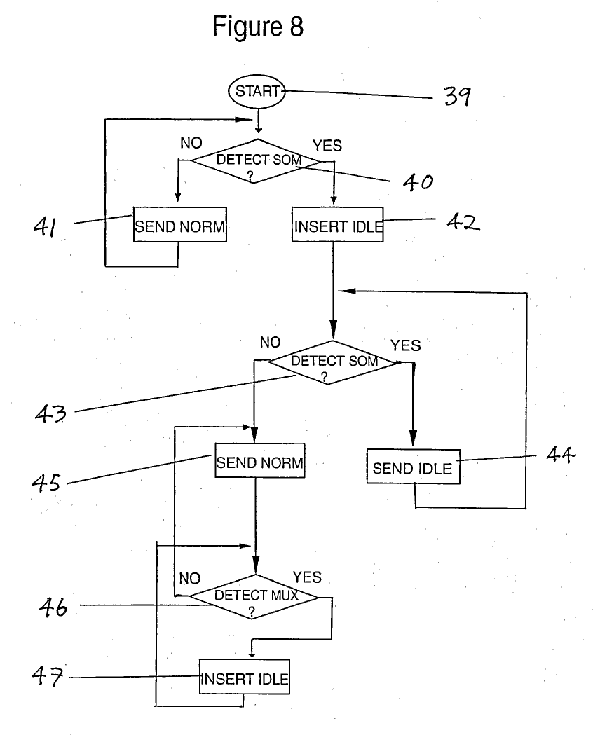

FIG. 8 presents a flow diagram of the method employed by the DEMUX 20 of the receiver 12 when operating to extract the additional input data “DatIn” 22 field so as to produce an additional output data “DatOut” 23 field. In general the states are advanced and decisions are made on the arrival of each character from the transmitter 8, via the propagation medium 11 and the input stage 19.

The Receiver START 39 stage is entered on a power on condition, external reset, manual reset override, whenever there is a loss of data synchronisation, or when no signal is detected due to an interruption of the data link from the input stage, as is typical of those systems known in the prior art. Following the Receiver START 39 stage a First DETECT SOM? 40 stage is entered on the arrival of the first character of the data stream. This stage branches YES only if a SOM character (not shown) is detected indicating that a transmitter 8 suitable for generating additional input data “DatIn” 22 fields is present on the physical link layer 15. On a NO branch being outputted no additional input data “DatIn” 22 characters are assumed to be capable, of being transmitted, therefore a first SEND NORM 41 stage of the DENUX 20 acts so as to pass data packets 10 through to the packet decoder 21 from the input stage 19.

However, when a YES branch is outputted by the First DETECT SOM ? 40 Stage a First INSERT IDLE 42 stage then strips the SOM character (not shown) and replaces it with an Idle character 24 that is then sent by the DEMUX 20 onto the packet decoder 21.

A Second DETECT SOM ? 43 stage is then employed to detect the presence of subsequent SOM characters (not shown). On a YES branch being outputted from the Second DETECT SOM ? 43 stage a Second INSERT IDLE 44 stage then strips the SOM character 25 and replaces it with an Idle character 24 that is then sent by the DENUX 20 to the data packet decoder 21. The DEMUX 20 state then returns to the Second DETECT SOM ? 43 stage. Thus, the SOM characters (not shown) are prevented from entering the data packet decoder 21, so as to avoid a potentially erroneous operation within it.

On a NO branch being outputted from the Second DETECT SOM ? 43 stage a Second SEND NORM 45 stage of the DEMUX 20 acts to pass the data packets 10 to the packet decoder 21 in the normal manner. The DEMUX 20 then progresses to a DETECT MUX ? 46 stage that monitors the data stream searching for the presence of the additional input data “DatIn” 22 field. When no additional input data “DataIn” 22 field is detected the DEMUX 20 returns to the Second SEND NORM 45 stage.

However, when the DETECT MUX ? 46 stage branches YES the DEMUX 20 moves to a Third INSERT IDLE 47 stage that acts to extract a character from the additional input data “DatIn” 22 field send it on as required within the additional output data “DatOut” 23 field. Simultaneously, the Third INSERT IDLE 47 stage replaces the extracted character with an idle character 24 that is sent on to the packet decoder 21. The DEMUX 20 then returns to the DETECT MUX ? 46 stage and repeats the above process so as to sequentially remove and replace all of the SOM 25, Control 26 and Data 27 characters of the additional input data “DatIn” 22 field. Once completed the DETECT MUX ? 46 stage branches NO and so the DEMUX 20 returns to the Second SEND NORM Stage 45.

The above description describes a method wherein the complete additional input data “DatIn” 22 field is inserted within an idle data field 14 at the physical link layer of a packet based communications systems 15. If the idle data field is not large enough to contain the full additional input data “DatIn” 22 field then the insertion process is stopped and commences again from the start when the next available idle data field 24 is detected. It will be apparent to those skilled in the art that the method may easily modified so that separate parts of the additional input data “DatIn” 22 field may be transmitted within different idle data fields 24. This could be achieved by the insertion of one or more END characters within the additional input data “DatIn” 22 field so that the receiver knows when a full additional input data “DatIn” 22 field has been transmitted. Alternatively, this could also be achieved by the use of additional special character codes that specifically mark the additional input data 22 as an incomplete field.

Further alternative embodiments that will be apparent to those skilled in the art include extending the described system to comprise more than one channel, two-way channels or multi-channel systems with additional input data “DatIn” 22 fields being exchanged between these channels.

The described method may also be readily incorporated within a number of transmission media including, but not limited to, over air, optical fibre, printed circuit board or cable. Similarly different types of transmission signal formats may be employed including, but not limited to, analogue, digital, modulated, un-modulated, return to zero coding, non return to zero coding, encoded data, non encoded data, multi-level, binary, continuous or discontinuous, framed, burst or packet based or any combination of these.

Different types of transmission techniques may also be employed including, but not limited to, electrical, electromagnetic, magnetic or optical means.

The described method relates to a communication system where only one transmitter and one receiver is used with one media channel. However, in alternative embodiments, transmission can be made from more than one transmitter sharing one or more media channels to one or more receivers. Furthermore the transmitter and the receiver are described as being two separate elements or components of the system. However, in alternative embodiments, the transmitter and the receiver can be joined or part joined within the same combined element or component of the system, as relevant to multi-channel bi-directional applications. In yet further alternative embodiments the transmitter and/or the receiver can comprise a different combination of separate elements in a combination with less or additional elements so as could be viewed to act as a transmitter and or receiver, respectfully.

Further alternative embodiments to the communication system include the system comprising:

additional filters, transducers, amplifiers, sensors or other elements or components between the transmitter and receiver.

separate sections of media, separated by filters, transducers, sensors, transponders, transceivers, transmitters, receivers or other elements so as the break the media into one or more sections of not necessarily the same type of media.

Alternative embodiments for the transmission of data within the physical layer include no idle characters being employed either side of the additional input data “DatIn” fields. Other coding schemes and data structures can also be readily incorporated within the additional input data “DatIn” fields. In particular the CNT data can contain a unique physical port address identifying that physical device on the link layer. This can be used, for example, in links where a device is employed as a physical layer repeater. Each device can then be pre-assigned or dynamically assigned the unique identifier as appropriate.

In a further embodiment of the above method it may be desirable not to extract the additional output data “DatOut” fields at the DEMUX but instead to employ this element to pass on or alternatively add additional data. This would be the case, for example, where the device is employed as a physical link layer repeater. This would allow for physical link information to permeate through the system to the channel final receiver. In this way the final receiver can gather all the additional input data “DatIn” fields on the link whilst each repeater in the link can also receiving its necessary physical link data. Such features can be added by having a suitable pass/block flag set in the control character CNT of the additional data field.

In a bi-directional or multi-directional communications system embodiment the control character field CNT, or elsewhere within the additional mux data field, may contain link status flags. These flags can be used to arrange a handshaking protocol for establishing link-up status between all sets of transmitters and receivers before any data is transferred and providing acknowledgement of successful data transfer in conjunction with a suitable error detection scheme in the data such as cyclical redundancy checking (CRC).

The above method provides a means for improving the efficiency of a packet based communications systems by exploiting existing relevant standards to transmit a quantity of additional data by encoding it within one of the existing fields of the defined packet structure. Such additional data can be used for any purpose as desired, but in the described embodiment the additional data is required specifically for the physical link. The information includes transmitter and receiver physical parametrics and such information is employed in addition to any existing data provisioned within any known standard.

The additional information is conveniently multiplexed within the physical link layer whilst being transparent to the normal packet based data. Employing this method puts no extra bandwidth requirement on the communications system. A significant benefit of multiplexing this data at the physical link layer itself is that it allows data to be added, extracted and stripped within the physical layer device at the point where the information is both available and required. This is architecturally efficient and leads to a performance, cost and size superior solution when compared to other conceivable alternatives.

The foregoing description of the invention has been presented for purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention herein intended.

1. A method of communicating information within a physical link layer of a packet based communication system, comprising the steps:
a) Employing a physical link layer transmitter to substitute an additional input data field within an idle data field of a data stream transmitted within the packet based communication system; and
b) Employing a physical link layer receiver to extract the additional input data field without corrupting information contained within the data stream.

2. The method of claim 1 wherein the step of substituting an additional input data field within an idle data field comprises the steps:
a) Detecting one or more idle data field characters; and
b) Replacing the one or more idle data field characters with one or more physical link layer data characters.

3. The method of claim 2 wherein the one or more idle data field characters to be replaced are located within two or more of the idle data fields.

4. The method of claim 2 wherein the step of extracting the additional input data field without corrupting information contained within the data stream comprises the steps of:
a) Detecting one or more physical link layer data characters; and
b) Extracting and replacing the one or more physical link layer data characters with idle field characters.

5. The method of claim 2 wherein the step of replacing the one or more idle field data characters with the physical link layer data characters comprises replacing one or more idle field data characters with a start data insertion multiplexer character.

6. The method of claim 5 wherein the step of replacing the one or more idle field data characters with the physical link layer data characters further comprises replacing one or more idle field data characters with a data control character.

7. The method of claim 5 wherein the step of replacing the one or more idle field data characters with the physical link layer data characters further comprises replacing one or more idle field data characters with an additional input data character.

8. The method of claim 2 wherein the step of replacing one or more idle data field characters with the physical link layer data characters further comprises the step of replacing one or more idle field data characters with an end input data character.

9. The method of claim 5 wherein the step of detecting the physical link layer data comprises activating a data extraction de-multiplexer when the receiver detects one or more start data insertion multiplexer characters.

10. A packet based communication system comprising one or more transmitters, one or more transmission media and one or more receivers wherein at least one of the one or more transmitters comprises a data insertion multiplexer for generating and inserting physical link layer data, and at least one of the one or more receivers comprises a data extraction de-multiplexer for detecting and extracting the physical link layer data.
